(19) United States
(12) Patent Application Publication
(10) Pub. No.: US 2008/0238063 A1
(43) Pub. Date: Oct. 2, 2008

(54) Trim Panel and Method of Manufacturing the Same

(76) Inventor: Vaughn D. Vanderpool, Fowlerville, MI (US)

Correspondence Address: HONIGMAN MILLER SCHWARTZ & COHN LLP, 38500 WOODWARD AVENUE, SUITE 100, BLOOMFIELD HILLS, MI, 48304-5048, US

(21) Appl. No.: 11/693,810

(22) Filed: Mar. 30, 2007

(51) Int. Cl. B60R 21/04

(52) U.S. Cl. 280/752; 425/500

(57) ABSTRACT

A trim panel includes a skin layer and an insert having a base, a sidewall that extends generally perpendicularly from the base and a flange that extends generally perpendicularly from the sidewall and generally parallel to the base. The flange includes a first side and a second side. The skin layer extends over at least a portion of said first side and said second side of said flange. A method for manufacturing a trim panel is also disclosed.

### BACKGROUND

1 Technical Field

The invention relates to a trim panel and a method for manufacturing a trim panel.

2. Description of Related Art

Trim panels are known in the art and are typically utilized for covering structure of vehicles and the like. Trim panels may include one or more layers, such as, for example, a substrate or base layer, an intermediate layer, and a skin.

### BRIEF DESCRIPTION OF THE DRAWINGS

The present disclosure will now be described, by way of example, with reference to the accompanying drawings, in which:

FIG. 1 is an inboard perspective view of an inboard side of a trim panel in accordance with an exemplary embodiment of the invention;

FIG. 2 is a cross-sectional view of the trim panel of FIG. 1 according to line 2-2;

FIGS. 3A-3C illustrate a mold tool and a method for manufacturing a trim panel in accordance with an exemplary embodiment of the invention;

FIGS. 4A-4C illustrate a cross-sectional view of a trim panel and mold tool corresponding to the method of manufacturing the trim panel of FIGS. 3A-3C; and

FIG. 5 is a perspective, partial cross-sectional view of a trim panel and mold tool cavity surface in accordance with an exemplary embodiment of the invention.

### DETAILED DESCRIPTION

The Figures illustrate an exemplary embodiment of a trim panel, and method of manufacturing a trim panel in accordance with an embodiment of the invention. The nomenclature used herein is simply for convenience and the terms used to describe the invention should be given the broadest meaning by one of ordinary skill in the art.

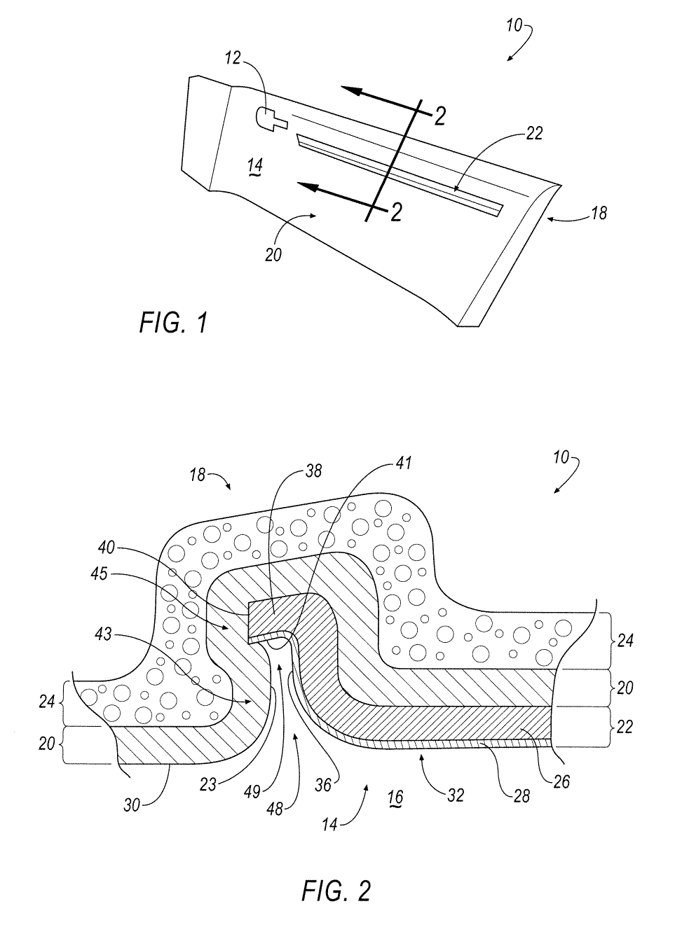

Referring to FIGS. 1 and 2, a trim panel is shown generally at 10 according to an embodiment. As illustrated in FIG. 1, the trim panel 10 defines structure, for example and without limitation, for an interior of a vehicle. In an embodiment, the trim panel 10 may define, among other features, one or more openings shown generally at 12 that provide a vehicle passenger access to, for example, a door handle, door lock controls, window opening/closing switches, and the like (not shown).

As seen in FIGS. 1 and 2, the trim panel 10 generally includes an inboard surface 14 that generally faces toward, and is at least partially exposed to, the interior compartment of a vehicle 16 (FIG. 2) when installed therein, and an outboard surface 18 that generally faces away from the interior compartment of a vehicle 16 when installed therein.

According to an embodiment, as shown in FIG. 2, the inboard surface 14 includes a skin layer 20 and an insert 22.

According to an embodiment, the skin layer 20 may be constructed of a cover stock material, including without limitation, formable thermoplastic material including, for example, Polyvinyl Chloride (PVC), or the like. The invention should not be limited to any particular application of the skin layer. For example and without limitation, the skin layer 20 may be preformed, molded, or a spray skin.

In an embodiment, the skin layer 20 may be attached to, directly or indirectly, a base layer 24. According to an embodiment, the base layer 24 may include, for example, a relatively soft, foam layer, and/or a relatively rigid layer. According to an embodiment, the base layer 24 may comprise a substrate material comprising, for example, a thermal plastic or rigid urethane, or the like. Other materials will become obvious based on this disclosure and the invention should not be limited thereby.

According to an embodiment, the insert 22 may include one or more layers. With reference to the illustration, two layers are shown generally at 26 and 28. Upon consulting this disclosure, however, it will become appreciated that any number of layers may be used and the invention should not be so limited thereby. The first layer 26 may be referred to as an outer layer and the second layer 28 may be referred to as the inner layer, but either layer 26, 28 can serve the dual role of an outer layer and an inner layer such that multiple layers can be avoided. The number of layers may be application specific while will become obvious based on this disclosure. The insert 22, and the outer layer 26 and/or inner layer 28 may be a pre-formed component including any desirable material, such as, for example, a rigid or non-rigid material, including but not limited to a moldable thermal plastic material.

As illustrated in FIG. 2, the skin layer 20 and the insert 22 each include a surface 30, 32 that will be at least partially exposed to a vehicular interior when the trim panel 10 is installed in the vehicle. According to an embodiment, the at least partially exposed surface 30 of the skin layer 20 may include a different texture and/or color than that at least partially exposed surface 32 of the insert 22. According to an embodiment, the at least partially exposed surface 30 of the skin layer 20 may include, for example, a fabric or leather texture having, for example, a black color whereas the at least partially exposed surface 32 of the insert 22 may include, for example, a relatively smooth texture having, for example, a blue color. Although fabric, leather, or smooth textures and black and blue colors are used to describe the above embodiment of the trim panel 10, it will be appreciated that the trim panel 10 is not limited to the above described embodiment and the surfaces 30, 32 of the trim panel 10 may include any desirable texture, color, material composition, or the like.

Referring to FIG. 2 and FIG. 4A, in an embodiment, the insert 22 includes a base 34, a sidewall 36 that extends generally perpendicularly from the base 34, and a flange 38 that extends generally perpendicularly from the sidewall 36 and generally parallel with the base 34. In combination with the skin layer 20, the flange 38 at least partially facilitates the connection between the insert 22 and the skin layer 20 via a retaining portion/lip 23 defined by the skin as will be described hereinbelow.

With continued reference to FIG. 2, FIG. 4A and FIG. 4B, the retaining lip 23 of the skin layer 20 provides a means for securing the insert 22 to the skin layer 20 via the interaction of flange 38 with the retaining lip 38. In an embodiment, at least a portion of the flange 38 is retained or enveloped by the retaining lip 23 to prevent relative movement. It will be appreciated that some, or all, of flange 38 may be covered by retaining portion 23 and the invention should not be so limited by the degree of covering.

In an embodiment, the skin layer 20 includes a plurality of turns or convex/concave portions 43, 45 that resemble a serpentine, snake-like, or S-shape pattern. Thus, upon considering the present disclosure, it will be appreciated, according to an embodiment, that the skin layer 20 contacts two or more surface portions of the insert 22, such as, for example, the flange 38, edge 40, inboard surface 41, and/or outboard surface 44 thereof. In an embodiment, the serpentitious cross-sectional arrangement 43, 45 of the skin layer 20 provides a mechanical or frictional connection that secures the skin layer 20 to the insert 22 such that a pre- or post-application of an adhesive, fasteners (e.g., heatstakes), or the like is/are eliminated from the structure of the trim panel 10.

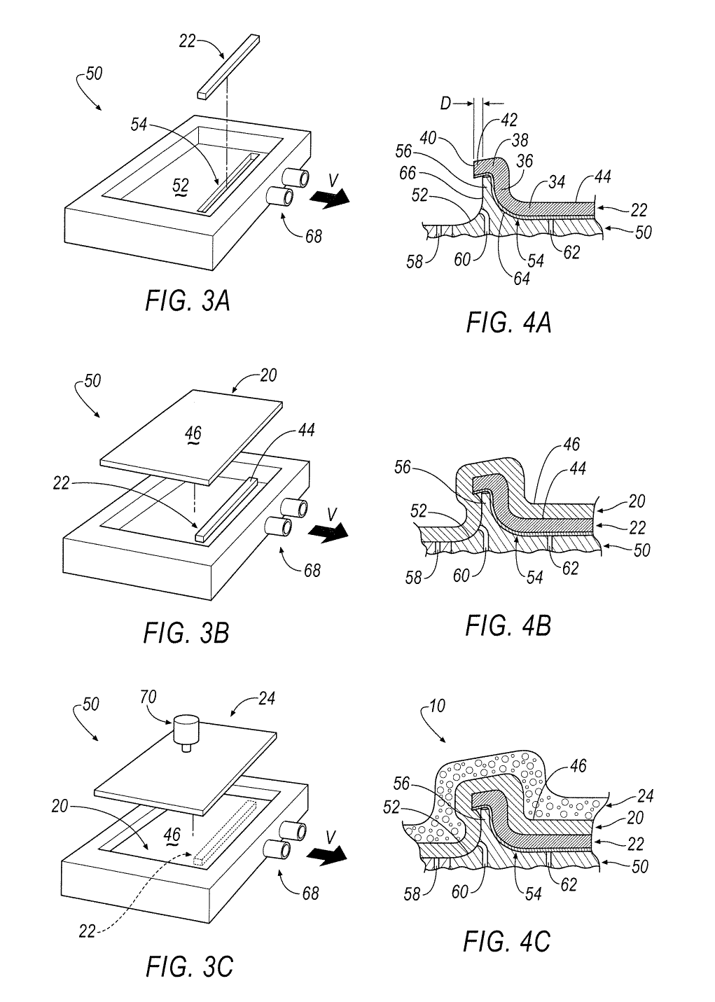

Referring now to FIGS. 3A-5, an exemplary method for manufacturing the trim panel 10 is shown. According to an embodiment, a mold tool is shown generally at 50 and includes a cavity surface 52. In an embodiment, the cavity surface 52 may include an insert nesting portion 54 having a lip 56 (FIGS. 4A-4C) that extends substantially perpendicularly from the cavity surface 52. Alternatively, the mold tool 50 may not include the nesting portion 54 and the inclusion of same may depend upon a variety of factors including, for example and without limitation, in cases where the insert exhibits sufficient structure to be self supporting, the nesting portion 54 may be removed. Based on this disclosure, it will also become appreciated that locators may be used to position the insert 22.

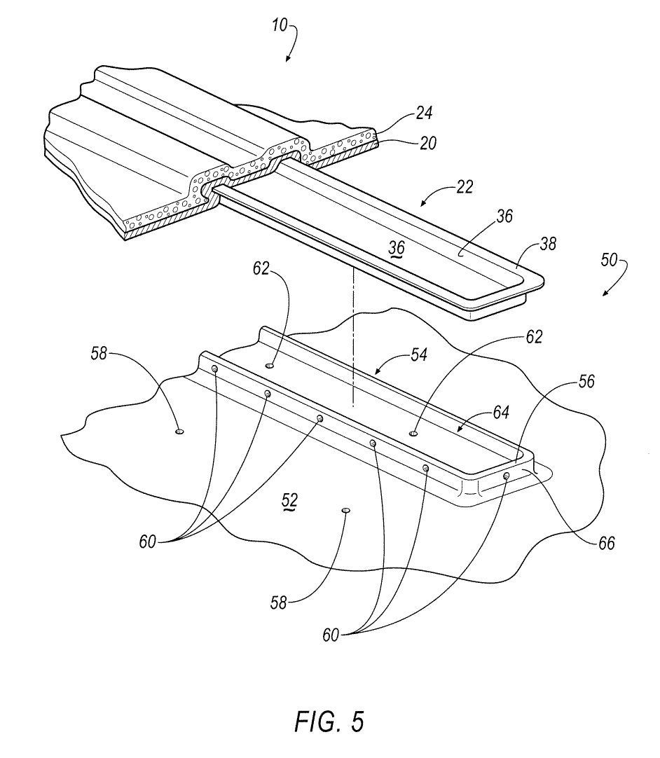

In an embodiment, one or more passages 58, 60, 62 (FIGS. 4A-4C and 5) may be provided in the cavity surface 52 for permitting a vacuum, V, to pull the outer surfaces 30, 32 of the skin layer 20 and/or insert 22 against the cavity surface 52.

Referring now to FIGS. 3A and 4A, a first step in a method of manufacturing the trim panel 10 is shown according to an embodiment. As described above, while the following description outlines a method for manufacturing a trim panel in a mold tool having a nesting portion, the nesting portion may be omitted provided the insert can be appropriately positioned therewithout. It is also to be appreciated that the method described herein is applicable to both embodiments and the invention should not be limited to the exemplary method employing the nesting portion.

With reference now to FIGS. 3A and 4A, the insert 22 is provided adjacent the insert nesting portion 54. If desired, a vacuum, V, is provided in the passage 62 to urge the insert 22 adjacent the cavity surface 52.

As illustrated, the sidewall 36 extends adjacently in a substantially perpendicular relationship to the mold tool surface 52 as the flange 38 is adjacently located in a generally cantilevered relationship parallel to the mold surface 52 such that an edge 40 of the flange 38 extends from the side wall portion 36.

Referring now to FIGS. 3B and 4B, the skin layer 20 is provided adjacent the cavity surface 52 and an outboard surface 44 of the insert 22. According to an embodiment, before, during, or after the skin layer 20 is provided adjacent the cavity surface 52 and/or outboard surface 44 of the insert 22, a vacuum, V, from a vacuum source (not shown) may be provided at the passages 58, 60 (see, e.g., FIGS. 4A and 5) to urge the skin layer 20 against the cavity surface 52. As illustrated, the vacuum, V (FIGS. 3A-3C), is provided from the vacuum source and is connected to the mold tool 50 at one or more ports 68.

Referring now to FIGS. 3C and 4C, the base layer 24 is provided adjacent an outboard surface 46 of the skin layer 20. If desired, the base layer 24 may be provided as a pre-formed sheet of material that may be shaped by the outboard surface 46 of the skin surface 20 as defined by the cavity surface 52 and outboard surface 44 of the insert 22 during a molding operation when the mold tool 50 is closed. Alternatively, if desired, rather than being inserted into the mold tool 50 as a pre-formed layer, the base layer 24 may be injected into the mold tool 50.

According to an embodiment, the mold tool 50 may be any desirable mold tool. For example, according to an embodiment, the mold tool 50 may be an injection or injection compression molding tool, structural reaction injection mold (SRIM) tool, or, alternatively, a low density structural reaction injection mold (LDSRIM) tool or the like. According to another embodiment, the use of a vacuum, V, and vacuum passages 58, 60, 62 may be obviated if, for example, the mold tool 50 is a melt compression molding (MCM) mold tool.

According to an embodiment, the turn or convex/concave portions 43 of the skin layer 20 may be formed during the expansion or injection of the base layer 24. In addition, the formation of the turn or convex/concave portions 43 of the skin layer 20 may be further formed by a vacuum, V, provided by the passage 60, as described in FIGS. 4B and 5. As illustrated, the passage 60 is formed in or proximate to sidewall 36of the cavity surface 52.

In an embodiment, the vacuum, V, provided by the passage 60 may aid the formation of the convex/concave portions 43 to thereby further define the other convex/concave portion 45 adjacent the edge 40 so as to provide the serpentitious cross-sectional arrangement 43, 45 of the sidewall 23 of the skin layer 20.

Accordingly, the present invention provides a trim panel 10 and method for manufacturing the same that eliminates additional components, manufacturing steps, and the costs associated with the same. For example, in the manufacture of conventional trim panels, a plurality of heatstakes may be included in a post-molding manufacturing step; as such, prior to inserting the heatstakes, a plurality of passages are provided in the conventional trim panel to permit insertion of the heatstakes. Once the heatstakes are inserted, the heatstakes are thermally or ultrasonically deformed so as to secure, for example, a decorative door trim bolster or the like to an trim panel. Because additional components, such as, for example, the door trim bolster insert 26 are secured to the skin layer 20 by way of the serpentitious cross-sectional arrangement 43, 45, additional fasteners, such as, for example, heatstakes, as well as the associated post-molding manufacturing step are thereby eliminated.

The present invention has been described with reference to certain exemplary embodiments thereof. However, it will be readily apparent to those skilled in the art that it is possible to embody the invention in specific forms other than those of the exemplary embodiments described above. This may be done without departing from the spirit of the invention. The exemplary embodiments are merely illustrative and should not be considered restrictive in any way. The scope of the invention is defined by the appended claims and their equivalents, rather than by the preceding description.

1. A trim panel, comprising:
a skin layer;
an insert having a base, a sidewall that extends generally perpendicularly from the base and a flange that extends generally perpendicularly from the sidewall and generally parallel to the base, wherein the flange includes a first side and a second side, wherein the skin layer extends over at least a portion of said first side and said second side of said flange, wherein the sidewall of the insert defines a first sidewall portion, wherein the skin defines a second sidewall portion, wherein the first and second sidewall portions are arranged in an opposing, spaced relationship and define a valley therebetween.

2. The trim panel according to claim 1, wherein the skin layer is defined to include at least
a convex portion that extends over said portion of said first side, and
a concave portion that extends over said portion of said second side.

3. The trim panel according to claim 2, wherein the convex and concave portions define a serpentitious cross-sectional arrangement of the skin layer.

4. The trim panel according to claim 1, wherein the flange is further defined to include
an edge, wherein the first side is further defined to include an inboard surface, wherein the second side is further defined to include an outboard surface, wherein the skin layer extends over a portion of the inboard surface of the flange, the edge of the flange, and the outboard surface of the flange.

5. A trim panel comprising:
a substrate layer defining an outboard surface and an inboard surface, wherein the inboard surface faces a passenger compartment of a vehicle;
a skin layer defining a first surface and a second surface, wherein the first surface is arranged adjacent inboard surface of the substrate layer, wherein the second surface faces the passenger compartment of the vehicle, wherein the skin layer defines a retaining portion;
an insert defining an A-surface, a B-surface, and an edge surface between the A-surface and the B-surface, wherein the B-surface and the edge surface are arranged adjacent the second surface of the skin layer, wherein a portion of the A-surface is arranged adjacent the second surface of the skin layer, wherein the A-surface of the insert faces the passenger compartment area of the vehicle, wherein the insert defines a flange that is retained by, the retaining portion.

6. The trim panel according to claim 5, wherein the retaining portion extends over a portion of the A-surface of the insert.

7. The trim panel according to claim 5, wherein the retaining portion is defined to include at least
a convex portion, and
a concave portion.

8. The trim panel according to claim 7, wherein the convex and concave portions define a serpentitious cross-sectional arrangement of the skin layer.

9. A method for manufacturing a trim panel, comprising the steps of:
providing a mold tool including a cavity surface and an insert nesting portion extending from the cavity surface;
providing an insert adjacent the insert nesting portion, wherein a portion of the insert extends away from the nesting portion;
providing a skin layer adjacent the cavity surface and an outboard surface of the insert; and
forming the skin layer to provide a means for securing the insert to the skin layer at the portion of the insert extending away from the nesting portion.

10. The method according to claim 9, wherein the forming step includes the step of enveloping the portion of the insert with a serpentitious cross-sectional arrangement defined by an A-surface of the skin layer.

11. The method according to claim 10, wherein the portion of the insert enveloped by the serpentitious cross-sectional arrangement of the A-surface of the skin layer is defined by an inboard surface, an outboard surface, and an edge surface between the inboard and outboard surfaces.

12. The method according to claim 9 further comprising the steps of
providing a base layer adjacent an outboard surface of the skin layer; and
forming the base layer to conform to the shape of the outboard surface of the skin layer.

13. The method according to claim 12, wherein, prior to the forming the skin layer and forming the base layer steps, providing an isocynate/polyol bind agent chemical mixture into the mold tool.

14. The method according to claim 9 further comprising the step of applying a vacuum to at least one of the skin layer and insert by way of one or more vacuum passages formed in the cavity surface, wherein the vacuum is applied to a sidewall of the skin layer defined by the insert nesting portion, wherein at least one of the one or more vacuum passages is formed in the insert nesting portion.

15-16. (canceled)

17. The trim panel according to claim 1, wherein the flange of the insert includes an inboard surface portion, wherein each of the first and second sidewall portions extend to the inboard surface portion, wherein the inboard surface portion defines a bottom of the valley.

18. The trim panel according to claim 1, wherein the trim panel defines an outboard surface and an inboard surface, wherein the insert defines a portion of the inboard surface and faces a passenger compartment of a vehicle.

19. The trim panel according to claim 1, wherein the valley defines a portion of the inboard surface and faces a passenger compartment of a vehicle.

20. The trim panel according to claim 5, wherein the insert includes a sidewall defining a first sidewall portion, wherein the skin defines a second sidewall portion, wherein the first and second sidewall portions are arranged in an opposing, spaced relationship defining a valley, wherein the flange of the insert includes an inboard surface portion, wherein each of the first and second sidewall portions extend to the inboard surface portion, wherein the inboard surface portion defines a bottom of a valley.

21. The trim panel according to claim 20, wherein the valley defines a portion of the second surface of the skin layer and the A-surface of the insert.
